(19) United States
(12) Patent Application Publication
(10) Pub. No.: US 2009/0242284 A1
(43) Pub. Date: Oct. 1, 2009

(54) TRANSPORTATION CART WITH ELECTRONIC CONTROLS, STEERING AND BRAKES SELECTIVELY CONFIGURED FOR RIDING AND WALKING MODES OF USE

(76) Inventor: Henry M. Whetstone, JR., St. Augustine, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/060,857

(22) Filed: Apr. 1, 2008

(51) Int. Cl. B62D 51/04

(52) U.S. Cl. 180/19.2

(57) ABSTRACT

A transportation vehicle configured for riding and walking modes of use includes a support frame having a front end and a rear end; and a plurality of front wheels rotatably coupled to the front end, and a plurality of rear wheels rotatably coupled to the rear end. A seat is coupled to the frame and configured to support a driver. A steering assembly is operably coupled to the front wheels and configured to controllably pivot the front wheels for steering. A braking system is operably configured to stop motion of the vehicle. A rigid walking arm is pivotally coupled to the steering assembly at a pivotally mounted end of the walking arm. Motor operation and braking controls are provided on the walking arm for walking mode and adjacent to the seat for riding mode. A relay disables controls for one mode (e.g., walking mode or riding mode controls) while the other mode is effective. Switching logic for selecting between walking mode and riding mode is also provided. A motor controller receives input from controls, sensors and switches, and governs motor speed and direction in accordance with preset walking mode and riding mode control parameters.

### FIELD OF THE INVENTION

This invention generally relates to transportation, and more particularly, to a small vehicle designed for either walking or riding modes of use and configured to transport one or more passengers, such as a golfer, and/or items, such as baggage.

### BACKGROUND

Personal transportation vehicles, such as golf carts, are commonplace. They are typically used where use of conventional automobiles is impractical. For example, they may be used in industrial facilities, airports, parks and communities; although, they are best known for service on a golf course. While such vehicles have proven to be very effective for transporting people and small loads within limited range, they typically are not configured to allow an operator to safely walk with the vehicle. This is a shortcoming because there are many occasions when an operator may want to walk with the vehicle, such as for purposes of exercise, careful maneuvering and increased visibility, and loading the vehicle to maximum capacity.

As one example, many golfers prefer walking at least part of the way during a round of golf. However, due to fatigue, age, health conditions, physical limitations, weather conditions, difficult terrain or other reasons, they either are simply incapable or prefer not to walk an entire course. Unfortunately, heretofore golfers have been constrained to choosing between walking or riding, before commencing a round of golf. A conventional motorized golf cart must be driven all the way around the course, eliminating any beneficial walking exercise. The alternative requires carrying a heavy bag, retaining an able-bodied assistant (i.e., a caddie) to carry the bag, or using a cart, whether a push, pull or motorized type, to carry the heavy bag, while the golfer commits to walking the entire course.

To address the need for a walking and riding golf cart, several walk and ride carts have been devised. Most of these dual-use (i.e., walk and ride) carts provide steering and power controls that are adjustable (e.g., extendible or pivoting) to facilitate access while walking or riding. For example, U.S. Pat. No. 5,346,028 and PCT Application WO2006032275 disclose an electric motorized cart equipped with a telescopically extendible steering column, which allows one to ride the cart or extend the column and walk behind the cart. The golf cart is controlled in the same manner, using the same controls and modes of use, when riding and walking. Similarly, European Patent EP1316334 and UK Patent GB2242404 disclose a cart with a pivoting steering assembly that allows the cart to be operated by a person sitting on the cart or pivoted forward for operation by a person walking in front of the cart. Some carts are chariot-style walk or ride devices, such as U.S. Pat. Nos. 4,538,695, 4,874,055 and 7,086,491 and PCT Application WO2006032275. Again, these carts are controlled in the same manner, using the same controls and modes of use, when riding and walking.

While the prior art carts effectively enable dual modes of use, they do not adequately distinguish between walking and riding modes. Speed and braking should be controlled differently in walking mode than in riding mode. For example, speed should automatically be limited to a safe pedestrian speed in walking mode. Brakes should be applied in walking mode whenever operator handling ceases. A one-handed controller should be provided for manipulating the vehicle while walking, while conventional vehicle braking, accelerating and steering controls may be provided for riding use.

The invention is directed to overcoming one or more of the problems and solving one or more of the needs as set forth above.

### SUMMARY OF THE INVENTION

To solve one or more of the problems set forth above, in an exemplary implementation of the invention, a transportation vehicle, such as (but not limited to) a golf cart is configured for riding and walking modes of use. The vehicle includes a support frame having a front end and a rear end; and a plurality of front wheels rotatably coupled to the front end, and a plurality of rear wheels rotatably coupled to the rear end. A seat is coupled to the frame and configured to support a driver. Driver controls are located adjacent to the seat, which means they are within reach of a seated driver. A steering assembly is operably coupled to the front wheels and configured to controllably pivot the front wheels for steering. A braking system is operably configured to stop motion of the vehicle. A rigid walking arm is pivotally coupled to the steering assembly at a pivotally mounted end of the walking arm. The walking arm has a free end opposite the pivotally mounted end. The walking arm is configured to cause the steering assembly to controllably pivot the front wheels for steering the vehicle. A riding steering apparatus is adjacent to the seat and operably coupled to the steering assembly and configured to cause the steering assembly to controllably pivot the front wheels for steering the vehicle. A motor is operably coupled to a drive train. The drive train is operably coupled to one or more of the rear wheels and configured to controllably rotate one or more rear wheels. A means for controlling operation of the motor in walking mode is attached to the walking arm adjacent to the free end. A means for controlling operation of the motor in riding mode is adjacent to the seat. A means for selecting between walking mode and riding mode is also provided. A means for controlling braking in walking mode is attached to the walking arm adjacent to the free end. A means for controlling braking in riding mode is adjacent to the seat. An electric power supply is electrically connected to the motor. The means for selecting between walking mode and riding mode includes a relay configured to disable the means for controlling operation of the motor in walking mode when riding mode is selected. A walking mode sensor electrically coupled to the relay is configured to disable the means for controlling operation of the motor in walking mode when riding mode is selected. The walking arm is pivotal from a stowed position to an operational position. The walking mode sensor detects when the walking arm is in the stowed position and when the walking arm is pivoted from the stowed position to the operational position. A means for selecting between walking mode and riding mode further includes a relay configured to disable the means for controlling operation of the motor in riding mode when walking mode is selected.

The means for controlling operation of the motor in walking mode includes a motor controller electrically coupled to the motor and configured to control and limit speed from zero to a determined maximum walking speed based upon a throttle input signal in walking mode, and further configured to control and limit speed from zero to a determined maximum riding speed based upon the throttle input signal in riding mode. The determined maximum riding speed is greater than the determined maximum walking speed. A throttle control is electrically connected to the motor controller and operably coupled to the walking arm adjacent to the free end, and configured to supply the throttle input signal in walking mode. The means for controlling operation of the motor in riding mode includes a riding throttle control electrically connected to the motor controller, operably positioned adjacent to the seat (i.e., within reach of a seated driver) and configured to supply the throttle input signal in riding mode.

In another aspect of another exemplary embodiment of the invention, the means for controlling operation of the motor in walking mode includes a motor controller electrically coupled to the motor and configured to control speed and direction of rotation of the motor based upon a throttle input signal and direction input signal. A user selectable forward-neutral-reverse switch is electrically coupled to the motor controller and configured to supply a direction input signal to the motor controller. A trim control is electrically connected to the motor controller and to a throttle control electrically connected (e.g., in series) to the trim control and operably coupled to the walking arm adjacent to the free end. The trim control is configured to regulate output from the throttle control. Together, the trim control and throttle control supply the throttle input signal to the motor controller during walking mode. Likewise, a trim control may be electrically connected to the motor controller and to a throttle control electrically connected (e.g., in series) to the trim control and operably located adjacent to the seat (i.e., within comfortable reach of a driver). This trim control is also configured to regulate output from the throttle control. Together, the trim control and throttle control adjacent to the seat supply the throttle input signal to the motor controller during riding mode.

In another aspect of another exemplary embodiment of the invention, the braking system operably configured to stop motion of the vehicle includes a mechanically actuated drum brake. The means for controlling braking in riding mode includes a manual actuator, such as but not limited to a foot actuated pedal adjacent to the seat and a linkage operably coupling the foot actuated pedal to the mechanically actuated brake, such as but not limited to a drum or disc brake. Alternatively, a hand actuated lever, such as but not limited to a motorcycle or bicycle handbrake actuator or an automobile parking brake style lever, may be used. The actuator may include a locking means, such as a catch at the end of a lever pull or other mechanical lock assembly, to secure the brake in a locked position. The linkage may include an expansion spring disposed between the foot actuated pedal and mechanically actuated drum brake and configured to actuate the mechanically actuated drum brake when not compressed. The means for controlling braking in walking mode includes a cable cam attached to the pivotally mounted end of the walking arm. The cable attaches to a linkage coupled to the mechanically actuated drum brake. The linkage may include an expansion spring disposed between the pulley and mechanically actuated drum brake and configured to actuate the mechanically actuated drum brake when not compressed.

In yet another aspect of another exemplary embodiment of the invention, a brake switch electrically connected to the motor controller may optionally be provided. Located adjacent to the seat or near the free end of the walking arm, the brake switch may supply a brake input signal to the controller. In response, the motor controller may cause the motor to function as an electric generator and supply electrical power to the rechargeable battery.

In still another aspect of an exemplary embodiment of the invention, a transportation vehicle configured for riding and walking modes of use includes a support frame having a front end and a rear end; and a plurality of front wheels rotatably coupled to the front end, and a plurality of rear wheels rotatably coupled to the rear end. A seat is coupled to the frame and configured to support a driver. A steering assembly is operably coupled to the front wheels and configured to controllably pivot the front wheels for steering. A braking system is operably configured to stop motion of the vehicle. A rigid walking arm is pivotally coupled to the steering assembly at a pivotally mounted end of the walking arm. Motor operation and braking controls are provided on the walking arm for walking mode and adjacent to the seat for riding mode. A relay disables controls for one mode (e.g., walking mode or riding mode controls) while the other mode is effective. Switching logic for selecting between walking mode and riding mode is also provided. A motor controller receives input from controls, sensors and switches, and governs motor speed and direction in accordance with preset walking mode and riding mode control parameters.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a profile of an exemplary dual mode of use vehicle, configured for either walking or riding modes of use, and configured to transport one or more passengers, such as a golfer, and/or items, such as baggage, according to principles of the invention; and

FIG. 2 shows a first perspective view of components of an exemplary dual mode of use vehicle, configured for either walking or riding modes of use, and configured to transport one or more passengers, such as a golfer, and/or items, such as baggage, according to principles of the invention; and

FIG. 2A shows a perspective view of components of an exemplary steering system for a dual mode of use vehicle according to principles of the invention; and

FIG. 2B shows a perspective view of components of an exemplary rear suspension and drive train for a dual mode of use vehicle according to principles of the invention; and

FIG. 3 shows a second perspective view of components of an exemplary dual mode of use vehicle, configured for either walking or riding modes of use, and configured to transport one or more passengers, such as a golfer, and/or items, such as baggage, according to principles of the invention; and

FIG. 4 shows a third perspective view of components of an exemplary dual mode of use vehicle configured with a control grip (or a joystick) and for either walking or riding modes of use, and configured to transport one or more passengers, such as a golfer, and/or items, such as baggage, according to principles of the invention; and

FIG. 5 shows a plan view of components of an exemplary braking system for an exemplary dual mode of use vehicle according to principles of the invention; and

FIG. 5A shows a schematic of various walking operational and non-operational ranges for an exemplary dual mode of use vehicle according to principles of the invention; and

FIG. 6 shows a high level schematic of components of an exemplary riding electronic control system for an exemplary dual mode of use vehicle according to principles of the invention; and

FIG. 7 shows a high level schematic of components of an exemplary walking electronic control system for an exemplary dual mode of use vehicle according to principles of the invention; and

FIG. 8A shows a perspective view of an exemplary walking arm in an extended position for a dual mode of use vehicle according to principles of the invention; and

FIG. 8B shows a perspective view of an exemplary walking arm in a collapsed position for a dual mode of use vehicle according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, shapes, relative sizes, ornamental aspects or proportions shown in the figures.

### DETAILED DESCRIPTION

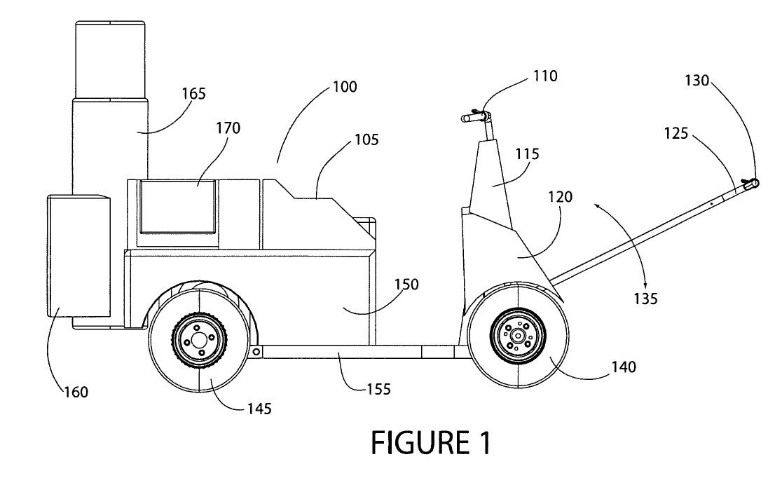

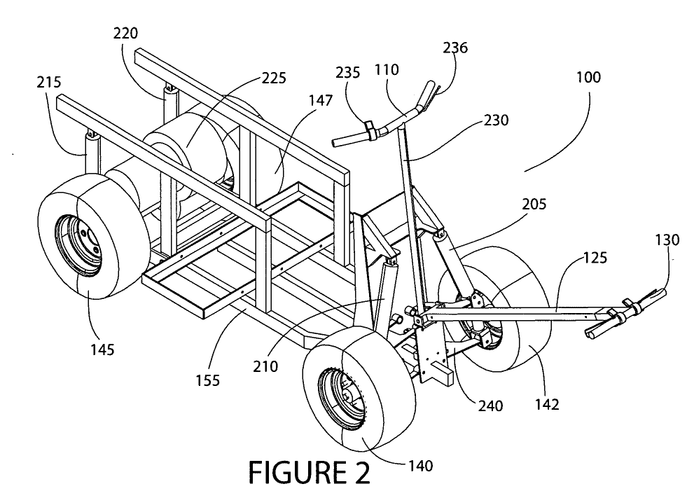

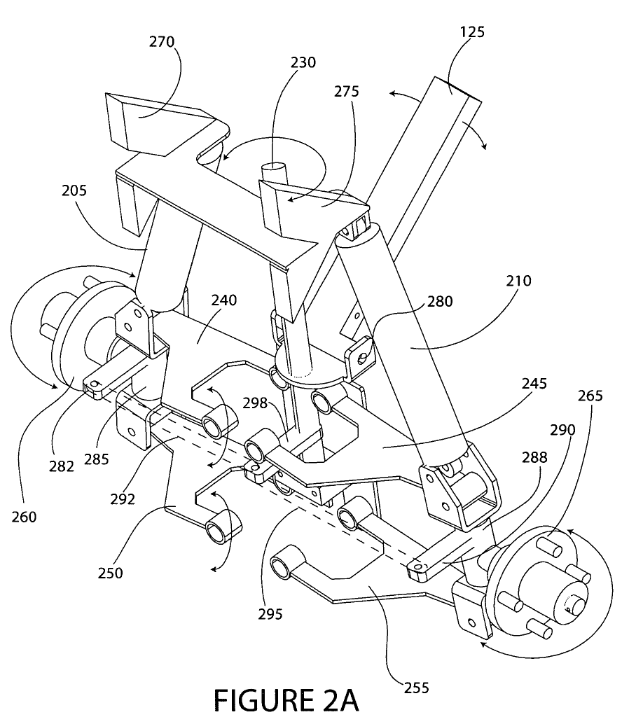

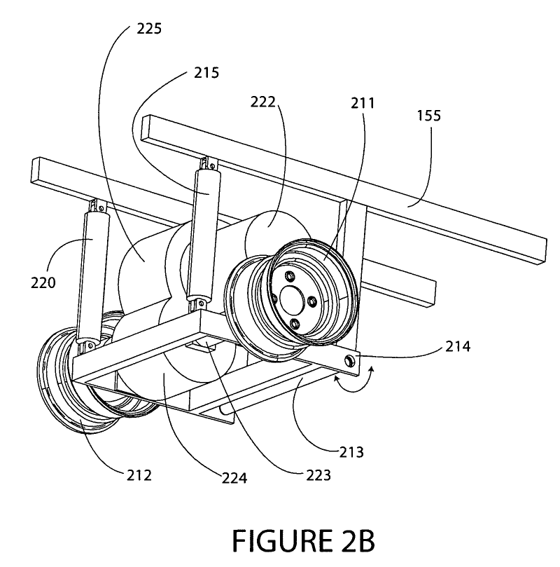

Referring to the Figures, in which like parts are indicated with the same reference numerals, various views of an exemplary dual mode of use vehicle and exemplary components thereof according to principles of the invention are shown. Referring specifically to FIG. 1, a profile of an exemplary dual mode of use vehicle 100, configured for either walking or riding modes of use, and configured to transport one or more passengers, such as a golfer, and/or items, such as baggage, according to principles of the invention, is provided. The vehicle 100 includes a frame 155, a plurality of wheels 140, 142, 145 and 147 (as shown in FIG. 2), a pivoting 135 walking arm 125 with controls 130 for walking mode use, a handlebar 110 for steering during riding, a console 115 with a fairing, a front nose and fender fairing 120, left and right side fender fairings 150, a seat 105, a storage compartment 170, and a holder 160 for a golf bag 165.

The walking arm 125 may be stowed when not in use. Illustratively, the walking arm 125 may be pivoted upward when not in use, to an axial position that is either substantially parallel or in-line with the steering column 230 (as shown in FIG. 2) rotational axis. The walking arm 125 provides a safe distance between the operator and the vehicle's front tires 140, 142. Because the elongated walking arm 125 may impede a seated driver's line-of-sight when rotated upward or stowed, in an alternative embodiment the walking arm 125 may be collapsible. For example, the arm 125 may be constructed using telescopic or folding sections.

As discussed more fully below, the exemplary vehicle 100 has two separate motor controller modes of operation, one for riding mode and one for walking mode. Each mode of operation has pre-determined limits for maximum speed, motor current, acceleration, deceleration, and braking. A feedback sensor 690 on the motor 222 provides input to the motor controller 600 to limit maximum speed in each mode. In riding mode, the maximum speed of operation is limited to conventional speeds allowed by golf carts, which may range from 10 to 14 miles per hour. In walking mode, the maximum speed is limited to a brisk walking pace, which may range from 3 to 4 miles per hour. The vehicle 100 has two separate sets of throttle 616, 720 and brake controls. One set is used in riding mode and the other is used in walking mode.

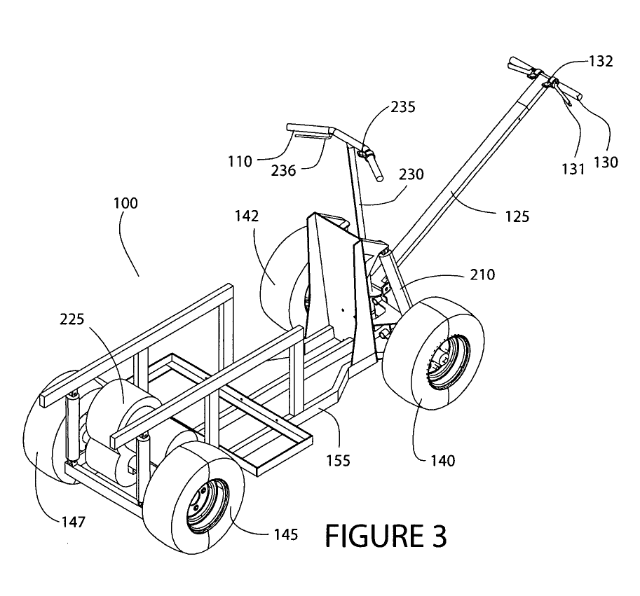

Referring now to FIGS. 2 and 3, perspective views of components of the exemplary dual mode of use vehicle, are provided. To better illustrate the frame, motor and suspension, all fairings, fenders, exterior panels, compartments, the seat, and holder are omitted. The frame 155 comprises a framework of connected durable, rigid support beams, to which the steering, suspension, braking and motor are operably coupled. So long as the frame 155 provides adequate support for all supported components (e.g., the motor and suspension, fairings, fenders, exterior panels, the seat, and holder), then the particular configuration and arrangement of support beams comprising the frame 155 is not particularly important and the invention is not limited to a particular frame configuration or arrangement. Frame configurations and arrangements other than as depicted are feasible and come within the scope of the invention.

The vehicle has two separate steering devices, a riding steering device used while a driver is seated on the vehicle and a walking steering device used while the operator walks in front of the vehicle. Controls, such as one or more throttle control 132, 235 and one or more brake actuators 131, 236 may be provided on the steering devices. Any compatible vehicle steering system may be used with a cart 100 according to principles of the invention. With reference to FIG. 2A, steering may, for example, be accomplished by rotating a steering column 230, which is operably coupled to the front wheels 140, 142 via steering components and linkages, such as steering knuckles 282, 290, 298 and tie rods 292, 295 (shown in dotted lines for clarity). Steering by exerting a rotational force either via the handlebars 110 (or a steering wheel) while riding or via the pivotally coupled 280 walking arm 125 while walking, causes the steering column 230 to rotate, which causes the steering arm 298 attached at the distal end of the steering column 230 to pivot. Pivotal motion of the steering arm 298 is transmitted via tie rods 292, 295 to the wheel steering knuckles 282, 290, causing the wheel steering knuckles 282, 290 to pivot and the steering collars 285, 288 to rotate. Rotation of the steering collars 285, 288 causes the wheel hubs 260, 265 to pivot. Such pivoting of the wheel hubs 260, 265 allows front wheels 140, 142 to correspondingly pivot, thereby causing the vehicle 100 to follow a desired course. The steering column 230 may optionally contain one or more universal joints to allow it to deviate somewhat from a straight line. Riding steering may operate through the one or more universal joints to provide off-axis rotation between the steering column and the handlebar or steering wheel, which will allow these devices to be mounted with optimum regard to a driver while in the seated position.

In an alternative embodiment, the walking arm 125 may be configured to act directly upon the front wheel steering knuckles 282, 290. Regardless of whether the walking arm 125 acts on the steering column 230 or the front wheel steering knuckles 282, 290, the walking arm 125 acts as a steering lever to the walking driver and the vehicle will follow behind the driver using a hand throttle and electric power. Either embodiment may include a steering box, such as a rack and pinion assembly. Various combinations of tie rod assemblies can be used to connect the steering knuckles 282, 290 to the steering column 230 or walking arm 125.

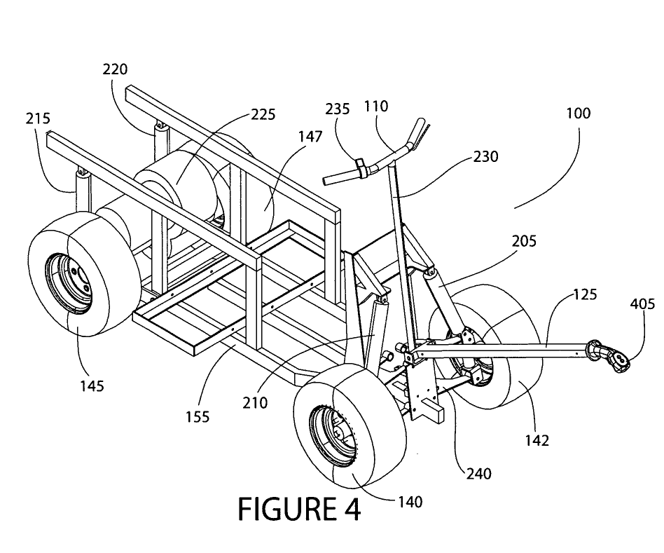

With reference to FIG. 4, in another embodiment the pivotally coupled 280 walking arm 125 is equipped with a control grip 405. The control grip 405 may include a plurality of switches and other controls to govern operation of the cart 100. The switches may be actuated conveniently by an operator's grip and finger action. The control grip 405 may be fixedly attached to the free end of the walking arm 125 and electrically coupled to an electronic controller (discussed below) that governs operation of the motor. A control grip 405 is preferred over a handlebar configuration because it is more easily grasped and managed by a pedestrian with one hand while walking ahead of the cart 100.

Non-limiting examples of alternative steering systems include rack and pinion and recirculating ball. In a rack and pinion system, rotation of the steering column 230 turns a pinion gear which moves a rack linearly. This linear motion applies steering torque to kingpins of the steered wheels via tie rods and the steering knuckles 282, 290. In a recirculating ball system, the rotating steering column 230 turns a large screw (i.e., “worm gear”) which meshes with a sector of a gear, causing it to rotate about its axis as the worm gear is turned. An arm attached to the axis of the sector moves a pitman arm, which is connected to a steering linkage and thus steers the wheels.

Advantageously, a cart 100 according to principles of the invention provides separate steering mechanisms for walking and riding. The walking mechanism, i.e., handle 125, is readily available for pedestrian use without need to adjust or reconfigure the mechanism, i.e., handlebars 110 (or a steering wheel) for riding use. Likewise, the riding mechanism, i.e., handlebars 110 (or a steering wheel), is readily available without need to adjust or reconfigure the mechanism, i.e., handle 125, for walking use.

Any compatible vehicle suspension system may be used with a cart 100 according to principles of the invention. The suspension system includes springs, shock absorbers and linkages that connect the wheels 140, 142, 145, 147 to the frame 155. The suspension system contributes to the vehicle's handling and attenuates road noise, bumps, and vibrations transmitted to the passenger compartment and vehicle occupants and cargo. The design of front and rear suspension of a car may be different. Illustratively, each front wheel 140, 142 may be mechanically linked to the frame by one or more stationary or movable linkages, such as upper and lower pivoting control arms 240, 245, 250, 255. Struts 205, 210 comprising springs to absorb impacts and dampers (e.g., shock absorbers) to dampen spring motion are connected to strut mounts 270, 275 and upper pivoting control arms 240, 245. The struts 205, 210 suppress road noise, bumps, and vibrations that are transmitted to the passenger compartment and vehicle occupants and cargo. As each front wheel 140, 142 may rise and fall on its own without affecting the opposite front wheel, the exemplary front suspension is an independent front suspension.

Referring now to FIG. 2B, a perspective view of components of an exemplary rear suspension and drive train for a dual mode of use vehicle according to principles of the invention is provided. The rear suspension includes a pivoting carriage 214 to which the drive train is attached. The carriage 214 is pivotally coupled to the frame 155 by a torsion bar 213. The torsion bar 213 may be a hinged joint or a torque biased spring configured to urge the end of the carriage 214 opposite the torsion bar away from the frame 155. Struts 215, 220 comprising springs to absorb impacts and/or dampers (e.g., shock absorbers) to dampen motion are each connected at one end to the frame 155 and at the other end to the end of the carriage 214 opposite the torsion bar away from the frame 155. The struts 215, 220 suppress road noise, bumps, and vibrations that are transmitted to the passenger compartment and vehicle occupants and cargo.

The invention is not limited to any particular drive train, i.e., the components between the motor 222 and driving wheel 212 or wheels 211, 212. Any drive train suitable for transmitting rotational force from the motor 222 to a driving wheel 212 or wheels 211, 212 may be utilized and is intended to come within the spirit and scope of the invention. In the exemplary embodiment depicted in FIG. 2B, the motor 222 is a direct current, variable speed, reversible electric motor (e.g., a 3.0 hp, 48 V DC electric motor transaxle). Operation of the motor 222, including speed and direction, is governed by an electronic controller, as discussed more fully below. The wheels are operably coupled to an axle 223. The motor is operably coupled to the axle by a transmission 225. The transmission may comprise a plurality of pulleys and a continuous belt contained within lower and upper housings 224, 225 with a driving pulley attached to the shaft of the motor and a driven pulley connected to the axle 223. Alternatively, a gear train or gear box contained within lower and upper housings 224, 225 and associated with the motor 222 shaft and axle 223 may transmit force from the motor 222 to the axle 223. A mechanical or electromechanical clutch, a fluid flywheel, or a torque converter may optionally be provided to controllably engage and disengage the transmission. The motor 222 in cooperation with the transmission 225 propels the vehicle at a walking or riding pace, depending upon the mode of use and speed of operation.

To manage speed, a speed sensor, such as a Hall effect sensor 690 is operably coupled to the motor shaft. The Hall effect sensor 690 provides a non-intrusive measurement and is available in a small IC package that combines the sensor and signal-conditioning circuit. Analog output voltage from the sensor 690 is input directly into the controller's ADC.

In the riding mode of vehicle operation, brake controls may be actuated by a foot-operated brake pedal on the vehicle floor or a hand-operated brake lever mounted on the handlebar or near the steering wheel. An alternative embodiment provides a hand-lever parking brake. In addition, these brake devices may also engage a mechanical parking brake by using a pull-cable linkage that includes an expansion spring 524 having a mechanical strength sufficient to engage the mechanical parking brakes without significantly extending the spring length.

In walking mode it may be desirable provide a mechanical parking brake that immediately engages if the driver releases a hand-on sensor 708. For safety reasons, it is desirable to require the driver to engage and lock a parking brake whenever the vehicle is not in motion. A mechanical parking brake override system is provided that uses the walking steering arm as a mechanical lever to actuate an override link cable. This cable and linkage assembly provides sufficient force to extend the expansion spring 524 and release the mechanical parking brake. As the walking steering arm is rotated downward from a near-vertical position, the override link cable causes the expansion spring 524 to extend and disengage the mechanical parking brake. If the walking steering arm is returned to the near-vertical position, the expansion spring 524 will reengage the brake.

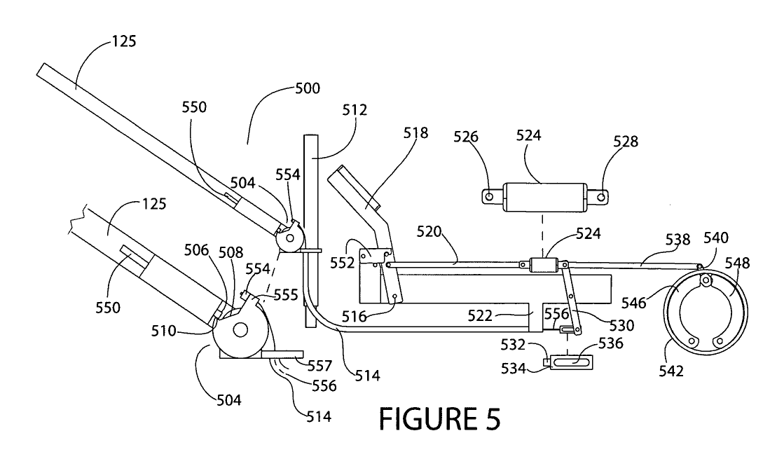

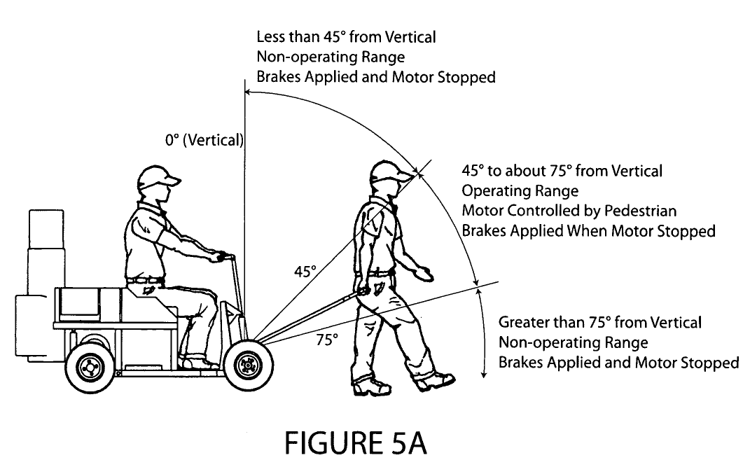

Referring now to FIG. 5, a plan view of components of an exemplary braking system for an exemplary dual mode of use vehicle according to principles of the invention, is provided. The exemplary braking system includes a foot pedal 518 connected via linkages 520 and 538 (e.g., brake cables) and an intermediate expansion spring 524 with pedal-side and brake-side connections 526, 528 to the actuator 540 of one or more drum brakes 542. A pivot mount 516, enables pivoting motion of the foot pedal 518. A lock 552, enables locking the pedal 518 in a depressed position. In riding mode, depressing the pedal 518 pulls the actuator 540, which urges the brake shoes 542, 548 against the inner walls of the drum brake 542, thereby generating frictional braking force. The expansion spring 524 regulates the maximum tensile force transmitted through the brake linkage 538. A parking brake may be electrically engaged whenever the throttle returns to the neutral of off position, or whenever the hand-on sensor 708 is activated.

For pedestrian braking, the pivoting walking arm 125 includes a releasable engagement pin 506 and a quick release switch 550. An override cable pull cam 504 is operably associated with walking arm 125, and particularly with the engagement pin 506. As the engagement pin 506 advances along the face 508 of the cam 504, it encounters a lip 510. Further advancement of the engagement pin 506 causes the cam 504 to rotate, which exerts tension on the override cable assembly 514, comprising a movable cable 556 in a concentric outer sheath. The ends of the outer sheath are secured to cable supports 522, 557. The cable 556 is operably coupled to a cam arm 555 via a cable stop collar 554. Pivoting motion of the cam arm 555 exerts or relieves tensile force on the cable 556. Pivoting motion of the walking arm 125 and engagement pin 506 against the lip 510 causes pivoting motion of the pull cam 504 and cam arm 555, which applies tension on the override cable assembly 514, which causes the cable 556 to move in the cable assembly 514.

A sliding joint 534 is attached at its neck 532 to the override cable assembly 514, or more particularly to cable 556. An elongated aperture 536 defines a range of free motion. Tension of the override cable 556 will not be transmitted to the pivoting linkage arm 530 until the range of free motion is exceeded, which is normally the non-operating range of rotation of walking arm 125. Releasing the quick release 550 activates the brakes when the walking arm 125 is in the operating position. The quick release may be electrically or mechanically actuated by the operator handle 130 or control grip 405 or motor controller 600.

With reference to FIG. 5A, the walking arm is configured to release the brakes in pedestrian mode while the walking arm 125 is within a determined operating range. The operating range may be defined by an angular position of the arm 125 relative to the horizontal, vertical or another reference plane. By way of example and not limitation, the operating range may be from a minimum angle (e.g., 15 to 60 degrees) from the vertical to a maximum angle (e.g., 60 to 85 degrees) from the vertical. In an exemplary embodiment, the operating range extends from about 45 to 75 degrees, providing a 30 degree range for operation of the vehicle. This range is within a normal holding position for an adult pedestrian.

The walking arm 125 has a plurality of electrically sensed positions that provide one or more inputs to the vehicle control logic. One or more sensors and/or switches may be provided to monitor angular position of the arm 125 and/or determine if the arm 125 is within operating range. Various electrical sensors may be used to detect the position of walking arm 125 and provide electrical input to the controller 600. For example, an on-off switch that senses a range of motion using a mechanical cam actuator, or a rotary sensor that electrically determines the axial position of the walking arm using a potentiometer or rotary encoder may be utilized. Analog and/or digital signals may generated by the sensors and/or switches. Such sensors may include any angular position sensors and/or switches that are known in the art and compatible with angular movement of the arm 125. The stowed position is a fixed mechanical position adjacent to or on the steering column axis. In the stowed position the walking arm 125 is held secure using a locking mechanism. The secure stowage of the walking arm 125 may be sensed by an on-off switch, which provides an electrical input to the vehicle control logic that is used as a condition to safely operate the vehicle in riding mode. The operating range as described above, is defined by an angular range extending where a driver typically holds the walking handle while walking ahead of the vehicle. The non-operating position is an angular range of motion extending upward between the stowage position and the beginning of the operating range. By signaling the controller to disable the throttle and, optionally, engage a parking brake, the non-operating positions prevents accidental operation of the vehicle as the driver rotates the walking steering arm from the stowage position to the operating position, and as the walking arm is dropped or otherwise allowed to pivot to the ground.

A preferred embodiment of a hand-on sensor 708 provides a mechanically or electrically actuated quick release device that releases the parking brake. This allows the expansion spring 524 to return to its original position and reengage the mechanical parking brakes. This provides an all-mechanical brake circuit, which may be perceived as safer than relying upon all-electrical brake system. The quick release device may be located at either end of the linkage cable.

The handle 130 or control grip 405 of the walking arm 125 may be gripped by one hand of a person walking ahead of the vehicle. The gripped portion has a throttle control, brake control and a hand-on sensor 708, all of which provide electrical inputs to the motor controller 600 in walking mode. For safety, controller 600 may be configured to require the hand-on sensor 708 to generate a signal corresponding to a detected hand to maintain control of the vehicle 100 at all times while walking. The hand-on sensor 708 on the handle 130 or control grip 405 may comprise a mechanical handle lever that activates an electromechanical switch or solid-state sensor, a non-contact proximity sensor or photo-electric device, or a push button situated on the handle. Safe operation of the vehicle in walking mode is provided by the vehicle control logic, which requires the following conditions to be met prior to operation: (i) the walking arm 125 must be in the operating position, (ii) the hand-on sensor 708 must be activated, and (iii) any telescoping or folding sections of the walking arm must be properly extended. Prior to any vehicle motion in walking mode, the driver's hand must engage the hand-on sensor 708, which is required as a logic condition prior to enabling vehicle motion. The hand-on sensor 708 may be interlocked with the throttle 616, 720 and control of a parking brake 610 to maximize safe operation of the vehicle.

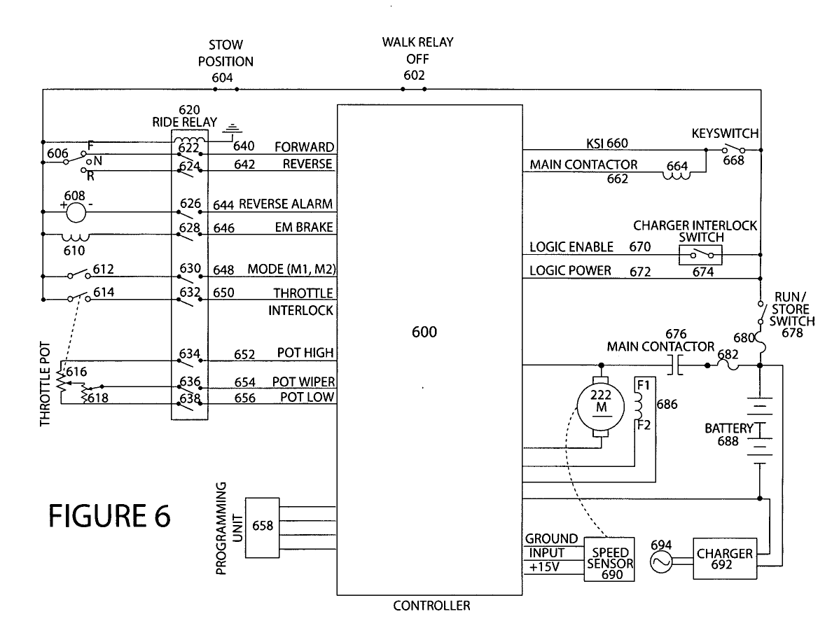

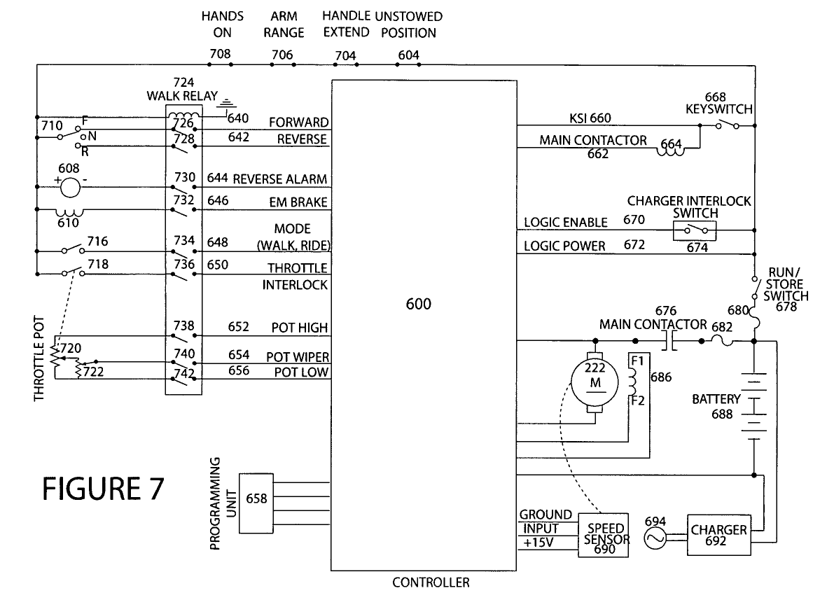

Referring now to FIGS. 6 and 7, high level schematic of components of an exemplary riding electronic control system for an exemplary dual mode of use vehicle according to principles of the invention, are provided. The controller 600 includes a central processing unit, discrete logical inputs and outputs allowing control or detection of logic states, analog outputs, a serial communications interface for system interconnect with programming and diagnostic devices, a clock/timer, volatile and/or nonvolatile memory for data and program storage, and one or more analog-to-digital converters. The motor controller 600 varies the drive output of motor 222 in response to an input signal from throttle controls 616, 618 and 720, 722. The motor controller may be a standard, commercially available electronic motor controller having reverse drive and braking functions. The motor controller is preferably a programmable controller of a type commonly used in forklifts and other industrial vehicle products. Such motor controllers are desirable because they can be custom configured to accommodate multiple speed modes, load compensation for maintaining constant speed when traveling up and down inclines, and anti-rolling functions. By way of example and not limitation, a suitable motor controller is a 48 V, 110 Amp Curtis 1266 electronic controller made by Curtis Instruments, Inc. of Mount Kisco, N.Y.

The exemplary motor controller has the following inputs: Motor Speed Sensor input, Throttle input, Battery Charger Interlock input, Reverse input, Forward input, Throttle Enable (interlock) input, Mode input, Keyswitch input, Run Enable input. The motor controller has the following outputs: Brake output, Reverse Alarm output, Main Contactor output.

One or more relays control inputs to the controller 600 for walk or ride mode functionality. For example, a ride relay 620 and a walk relay 724, or an integrated ride/walk relay, enable inputs to the controller 600 for selecting ride or walk modes. Thus, in ride mode, the relay 620 allows inputs to the controller from ride mode controls and switches. In walk mode, the relay 724 allows inputs to the controller from walk mode controls and switches. In walk mode, the ride mode controls and switches do not influence the controller 600. Likewise in ride mode, the walk mode controls and switches do not influence the controller.

Control switches for operating the motor 222 to propel the vehicle may be provided at any convenient place on the vehicle. As illustrated in the schematics of FIGS. 6 and 7, a mode control switch integrated with the walking arm 125 provides a signal that alerts the controller 600 to walking mode or riding mode. When the arm 125 is in the vertical stow position 604, riding mode is indicated and the walk relay 724 is off 602 and the corresponding walk mode switch 716 and relay 734 are in an open state. When the arm 125 is unstowed 604, in extended 704, walking operational range 706, within a pedestrian operator's hand 708, walking mode is indicated and the ride relay 620 is off. The maximum attainable speed in walking mode is less than the maximum allowable speed in riding mode.

Switch 708 is an electrically linked dead man's switch, provided to prevent locomotion when released, such as if the human operator releases the arm 125 in walking mode or becomes incapacitated. The switch 708 must be actuated to complete a circuit between the battery 688, through the controller 600 to the electric motor 222.

A three position direction switch 606, 710 is provided on the console 115 and on the walking arm controller (i.e., the handle 130 or control grip 405). The direction switch 606, 710 conveniently has a forward drive position, a reverse drive position, and an intermediate neutral position. The direction switch 606, 710 is operable to reverse the polarity of the battery 688 voltage applied to the DC motor 222 to reverse the motor rotation.

The motor 222 is powered by one or more rechargeable batteries 688. The preferred type of battery is deep cycle, such as a deep-cycle lead-acid battery designed to deliver a consistent voltage as the battery discharges. The motor's field connections (F1 and F2) 686 determine the direction of vehicle travel with the forward direction selected.

Throttle control is achieved through a potentiometer that is responsive to rotation, translation or other manipulation by a user. Various throttles may be used with the controller 600, including potentiometers that provide a variable resistance dependent upon position, which is used as an input to the controller. In a preferred embodiment, two potentiometers in series comprise each of the walk and ride throttle controls 616, 618 and 720,722. One potentiometer 616, 720 serves as the throttle, while the other 618, 722 provides trim control 618, 722 that limits the output to a maximum voltage (e.g., a maximum of less than 5 volts). The throttles 616, 720 are activated in a single direction of rotation and are biased (e.g., spring-returned) to a neutral or off-position when released by the driver. Although the controller 600 limits the maximum speed in walking mode, the trim control 618, 722 further reduces the maximum speed by limiting the throttle movement or reducing the electrical output of the throttle potentiometer. The benefit of trim control 618, 722 is that a slower walking person may reduce the maximum speed and still fully engage the throttle 616, 720, which provides the driver with a repeatable and easy to use speed control device adjusted to an individual pace of walking. This speed trim control 618, 722 can be located on the walking arm 125 and on the vehicle console 115. Controller 600 output to the motor 222 is possible only when the throttle interlock input 614, 718 for the active throttle is engaged. The controller receives a voltage signal at the potentiometer wiper input 654, with vehicle speed increasing with increased throttle voltage. The voltage source and return to the throttle is provided by the controller, with potentiometer high 652 providing a current limited 5V source to the throttle, and potentiometer low 656 providing a return path. The ride and walk relays 620, 724, disrupt or complete connections 634-638, 738-742 between the throttles 616-618, 720-722, depending upon the mode of operation. Thus, the ride throttle 616-618 functions in ride mode, while the walk throttle 720-722 functions in walk mode. A throttle on-off switch (e.g., throttle interlock 614, 718) is provided at the beginning of the throttle's range-of-rotation to provide an additional input to the vehicle control logic or motor controller that protects against unintended vehicle movement.

In the exemplary embodiment, a plurality of switches are provided to controllably enable and disable operation. A key switch 668 located on the console is connected to a key switch input 660 enables and disables operation. A run/store switch 678 located in an out-of-the-way location also enables and disables operation, but is left on except when the vehicle will be stored or is being towed. The key switch 668 and the run/store switch 678 provide current to drive the motor 222 via the controller 600.

The controller 600 provides three drivers for an emergency brake 646, a reverse alarm 644, and main contactor 662. These three outputs are low-side drivers, configured to controllably energize inductive coils, a piezoelectric reverse alarm or a similar component. The controller may include voltage drivers to limit these outputs to a determined percentage of system voltage and coil suppression diodes to protect drivers from inductive spikes generated at turn-off. The main contactor coil 664 activates and deactivates the main contactor 676, which allows the controller 600 and motor 222 to be connected and disconnected from the battery 688. A fuse 682 is provided between the battery 688 and main contactor 664. Through the main contactor coil 664 in concert with the main contactor 676, battery power can be removed from the drive system if a controller 600 or other wiring fault is detected. The reverse alarm driver 644 drives a reverse signal beeper or piezo-electric buzzer 608 that operates when the vehicle is traveling in reverse. The emergency brake driver 646 drives a brake coil 610 that releases the brakes when the vehicle is commanded into motion.

Programmable parameters such as current limits, acceleration and deceleration rates, braking parameters, and speed parameters may be set by interfacing the controller 600 with a programming unit 658 via a serial interface or other compatible communication link. Programming instructions and data may be stored in a PROM, EEPROM or other volatile memory in the controller. For riding mode, the exemplary motor controller 600 has the following programmable parameters: Main Current Limit, Acceleration Rate (e.g., the time, in seconds, for the controller to accelerate from 0% output to 100% output), Deceleration Rate (e.g., the time, in seconds, for the controller to reduce the average voltage at the motor armature output from 100% PWM to 0% PWM), Brake Minimum (e.g., the max brake actuating current at low speeds), Brake Maximum (e.g., the max brake actuating current at low speeds), Brake Map (e.g., a percentage of the brake actuating current between the BRAKE MIN and BRAKE MAX values, at a midpoint that is halfway between the BRAKE END and BRAKE START speeds), Brake Start (e.g., vehicle speed at which the brake map starts to increase from the BRAKE MIN value), Brake End (e.g., the vehicle speed at which the brake map reaches the BRAKE MAX value), Forward Speed (e.g., maximum walking speed in riding mode), and Forward Field Minimum (e.g., the minimum field current in riding mode). For walking mode, the motor controller has the following programmable parameters: Brake Minimum (e.g., the max brake actuating current at low speeds), Brake Maximum (e.g., the max brake actuating current at low speeds), Brake Map (e.g., a percentage of the brake actuating current between the BRAKE MIN and BRAKE MAX values, at a midpoint that is halfway between the BRAKE END and BRAKE START speeds), Brake Start (e.g., vehicle speed at which the brake map starts to increase from the BRAKE MIN value), Brake End (e.g., the vehicle speed at which the brake map reaches the BRAKE MAX value), Forward Speed (e.g., maximum walking speed in walking mode), and Forward Field Minimum (e.g., the minimum field current in walking mode).

As a safety measure, a battery charger interlock 674 prevents motor operation during charging. A battery charger 692, which may be external to or installed on the vehicle 100, converts AC utility power 694 to DC current output for charging the batteries 688. The output current depends upon the state of the batteries 688. The charger monitors the voltage of the batteries 688, temperature and time under charge to determine a charge current. Charging terminates when a combination of the voltage indicates that the batteries 688 are fully charged. The voltage across the batteries 688 increases slowly during the charging process, until the batteries 688 are fully charged. After that, the voltage decreases, which indicates that the batteries 688 are fully charged. Optionally, when the batteries are charged up to about 85% of its maximum capacity, the charger 692 may switch to trickle charging to charge the batteries 688 slowly to full capacity.

An electronic brake control may be provided in various embodiments as a brake potentiometer or coil (e.g., relay) 610, a brake on-off switch, a combination brake device combining a potentiometer and an on-off switch. An alternate embodiment of the brake control is to utilize a single electrical device and to mechanically actuate the brake sensor using one or more brake cables. The brake control is activated in a single direction of rotation and/or translation and is spring returned to a neutral or off-position when released by the driver. The brake control may be a potentiometer or an on-off switch that provides input to the vehicle control logic or motor controller and may include an additional on-off switch at the end of its range-of-rotation that engages a parking brake. A mechanical or electrical locking device at the end of the mechanical range-of-motion may maintain the vehicle parking brake. A further embodiment of the brake sensor uses the throttle sensor input to compare the driver's commanded vehicle speed with the actual vehicle speed. This comparison may occur in the vehicle control logic or the motor controller. When it is determined that the vehicle is operating at a speed greater than the speed commanded by the throttle sensor, various known braking systems may be applied such as regenerative braking, armature-field motor braking, wheel shaft drum or disk brakes, or motor shaft drum or disk brakes.

Actuation of a throttle control or brake control can be provided by a rotating hand-grip device or a thumb-finger-lever device. The throttle control and brake control may be combined into a single operator point of control on the walking arm 125, which may include two separate potentiometers and two separate on-off switches operating about a common rotational axis. The throttle and brake controls typically actuate in opposite directions of rotation. Two separate biasing means (e.g., springs) and mechanical stops provide a neutral or off-position between the throttle range-of-rotation and the brake range-of-rotation. Placing the throttle and brake onto a common rotational axis provides an operator with ability to use one hand or a finger to control all vehicle movement.

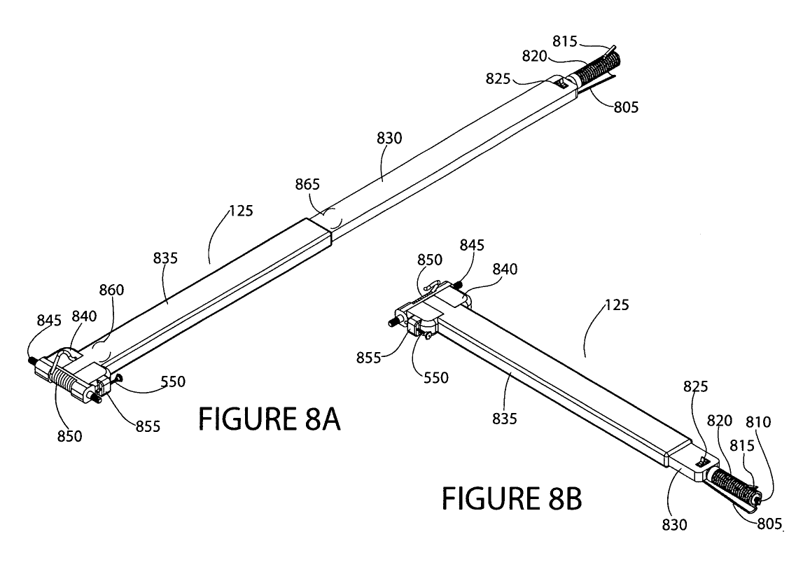

A telescopic walking arm 125 is conceptually illustrated in FIGS. 8A and 8B. A smaller diameter sliding section 830 is telescopically engaged by a base section 835 of the walking arm. The extended walking arm 125 is rigid. Various mechanical and electromechanical locking devices may be provided to lock the sections 830, 835 in an extended or collapsed orientation. Importantly, the extended arm is long enough to maintain a safe distance between a pedestrian user and the front of the vehicle. Thus, a safe buffer distance of one foot or more should remain between the heels of a pedestrian user in a normal stride and all structures of the vehicle, including but not limited to the front wheels. Extended lengths of three feet or more are preferred.

The walking arm includes various controls, some of which may be utilized for both walking and riding modes of use. For example, a three-way forward-neutral-reverse switch 825 is disposed on the based section in a position accessible to both pedestrian users and drivers. Thus, when the user is walking, the user may control direction of travel using the forward-neutral-reverse switch 825 positioned within reach of the control grip 820. Likewise when the walking arm 125 is collapsed and pivoted upright for driving mode use, the driver may control direction of travel using the forward-neutral-reverse switch 825, which is then well within reach of a seated driver. Other controls on the control grip 820 include a hand-on switch also known as a dead man's switch 805, a throttle control 815 and a throttle trim control 810. Locomotion is disabled and braking is applied unless the dead man's switch 805 is depressed, the walking arm 125 is within operational range, the forward-neutral-reverse switch 825 is in forward or reverse position, and the throttle 815 is depressed.

Various sensors and switches may be included on or within the walking arm 125 to detect orientation. For example, one or more safety switches 860, 865 within the telescopic sections 830, 835, may sense when the walking arm 125 is fully extended and when the walking arm is fully collapsed. An angular sensor such as one or more positional switches, a rotary potentiometer or a rotary encoder may be included in an electronics compartment 840 adjacent the axle 845 and configured to generate an output signal corresponding to angular orientation of the walking arm 125 relative to the axle 845 or another reference axis. Riding mode may be disabled when the walking arm 125 is not fully collapsed and pivoted and locked in a substantially vertical orientation for riding mode. Likewise, walking mode may be disabled when the walking arm 125 is not fully extended and pivoted into operational range.

Springs and dampers may be provided to facilitate handling and restraint of the walking arm 125. By way of example and not limitation, a biasing means such as a torsion spring 850 may exert a torque towards the vertical position, the magnitude of the torque increasing with pivoting away from the vertical position. The force should be sufficient to counteract at least some of the downward force due to the weight of the arm. Thus, the torsion spring 850 facilitates holding the walking arm 125 in operational range for an extended period of time. Additionally, if a user drops the arm, the counteracting torque will reduce the impact, i.e., net downward force, of the arm 125 against the ground, a foot or some other obstacle. The mitigated impact will help protect the integrity of the arm and its components, while preventing serious damage to impacted feet and ground surfaces. To further dissipate kinetic energy of the moving arm 125, one or more shock absorbers may operably couple the arm 125 to the frame or another supportive structure.

Adjacent to the axle 845, a shoulder 855 supports the optional quick release switch 550. The quick release switch may be manually or electrically actuated to release or actuate fail safe braking when the walking arm 125 is in operational position.

While the principles of the invention may apply to a multi-passenger vehicle and the invention is not limited to any particular passenger configuration, in a preferred exemplary embodiment, a vehicle according to principles of the invention is configured with one seat for one person. In the preferred embodiment, the area occupied by the preferred embodiment is approximately ½ the area occupied by a conventional two-person golf cart. Thus, a vehicle storage area at a golf club may accommodate twice as many of the single person vehicles according to the invention than conventional two-person golf carts. This provides many advantages. The opportunity for revenue generation is greater. It is also far more efficient to provide a single-person golf cart to a single golfer than it is to provide a two-person golf cart to a single golfer. Additionally, a golf cart per person provides added convenience, allowing each golfer to follow their own route, at their own pace, and carry their clubs to each of their shots, without inconveniencing other players in a group.

By way of example and not limitation, the overall length of a single person vehicle according to principles of the invention with the walking arm in the stowed upright position is about 48 to 60 inches, and the overall width is approximately 30 to 36 inches, providing an overall area between 1440 in² to 2,160 in². In contrast, a conventional two-person golf cart has a length of about 94 inches, a width of about 48 inches, occupying an area of over 4,400 in².

Although the invention has been described with reference to a specific embodiment, the foregoing description is not intended to be construed in a limiting sense. Various modifications to the disclosed embodiment as well as alternative applications of the invention will be suggested to persons skilled in the art by the foregoing specification and illustrations. It is therefore contemplated that the appended claims will cover any such modifications, applications or embodiments as fall within the true scope of the invention.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1-28. (canceled)

29. A vehicle for riding and walking modes of use, the vehicle comprising:
a frame;
at least one seat coupled to said frame;
a plurality of wheels rotatably coupled to said frame;
at least one motor for driving at least one wheel of said plurality thereof;
a steering assembly coupled to at least one wheel of said plurality thereof;
a riding steering apparatus coupled to the steering assembly for the riding mode of use;
a riding throttle coupled to said at least one motor for the riding mode of use;
a walking steering apparatus coupled to said steering assembly for the walking mode of use; and
a walking throttle carried by said walking steering apparatus to control said at least one motor for the walking mode of use.

30. The vehicle of claim 29 wherein said walking steering apparatus is movable from a stowed position to an extended operational position; wherein said riding throttle is disabled when said walking steering apparatus is in the extended operational position; and wherein said walking throttle is disabled when said walking steering apparatus is in the stowed position.

31. The vehicle of claim 30 wherein said walking steering apparatus comprises a rigid arm pivotally coupled at its lower end to said steering assembly, and carrying said walking throttle at its upper end.

32. The vehicle of claim 29 further comprising a controller coupled to said riding throttle, said walking throttle, and said at least one motor; and wherein said controller limits a speed of said at least one motor based upon the mode of use.

33. The vehicle of claim 29 further comprising:
a braking system;
a riding brake coupled to said braking system for the riding mode of use; and
a walking brake carried by said walking steering apparatus and coupled to said braking system for the walking mode of use.

34. The vehicle of claim 33 wherein said walking steering apparatus is movable from a stowed position to an extended operational position; wherein said riding brake is disabled when said walking steering apparatus is in the extended operational position; and wherein said walking brake is disabled when said walking steering apparatus is in the stowed position.

35. The vehicle of claim 33 further comprising a controller coupled to said braking system; wherein said riding brake is electrically coupled to said controller; and wherein said walking brake is electrically coupled to said controller.

36. The vehicle of claim 33 wherein said braking system comprises a regenerative braking system; and further comprising a rechargeable power supply carried by said frame and coupled to said regenerative braking system.

37. The vehicle of claim 33 wherein said braking system comprises a friction braking system.

38. The vehicle of claim 29 further comprising:
a riding forward-neutral-reverse switch carried by said frame and coupled to said at least one; and
a walking forward-neutral-reverse switch carried by said walking steering apparatus and coupled to said at least one motor.

39. The vehicle of claim 29 wherein said frame has a front end and a rear end; wherein said plurality of wheels comprises a pair of rear wheels carried by the rear end, and a pair of front wheels carried by the front end; and wherein said steering assembly is coupled to said pair of front wheels.

40. The vehicle of claim 39 wherein said at least one motor drives said pair of rear wheels.

41. A vehicle for riding and walking modes of use, the vehicle comprising:
a frame having a front end and a rear end;
at least one seat coupled to said frame;
a plurality of front wheels rotatably coupled to the front end and a plurality of rear wheels rotatably coupled to the rear end;
at least one motor for driving at least one wheel of said plurality thereof;
a steering assembly coupled to the plurality of front wheels;
a riding steering apparatus coupled to the steering assembly for the riding mode of use;
a riding throttle coupled to said at least one motor for the riding mode of use;
a walking steering apparatus coupled to said steering assembly for the walking mode of use;
a walking throttle carried by said walking steering apparatus to control said at least one motor for the walking mode of use;
a braking system;
a riding brake coupled to said braking system for the riding mode of use; and
a walking brake carried by said walking steering apparatus and coupled to said braking system for the walking mode of use.

42. The vehicle of claim 41 wherein said walking steering apparatus is movable from a stowed position to an extended operational position; wherein said riding throttle is disabled when said walking steering apparatus is in the extended operational position; and wherein said walking throttle is disabled when said walking steering apparatus is in the stowed position.

43. The vehicle of claim 42 wherein said walking steering apparatus comprises a rigid arm pivotally coupled at its lower end to said steering assembly, and carrying said walking throttle at its upper end.

44. The vehicle of claim 41 further comprising a controller coupled to said riding throttle, said walking throttle, and said at least one motor; and wherein said controller limits a speed of said at least one motor based upon the mode of use.

45. The vehicle of claim 41 wherein said walking steering apparatus is movable from a stowed position to an extended operational position; wherein said riding brake is disabled when said walking steering apparatus is in the extended operational position; and wherein said walking brake is disabled when said walking steering apparatus is in the stowed position.

46. A method of making a vehicle for riding and walking modes of use, the method comprising:
coupling at least one seat to a frame;
rotatably coupling a plurality of wheels to the frame;
coupling at least one motor to at least one wheel of the plurality thereof;
coupling a steering assembly to at least one wheel of the plurality thereof;
coupling a riding steering apparatus to the steering assembly for the riding mode of use;
coupling a riding throttle to the at least one motor for the riding mode of use;
coupling a walking steering apparatus to the steering assembly for the walking mode of use; and
positioning a walking throttle to be carried by the walking steering apparatus to control the at least one motor for the walking mode of use.

47. The method of claim 46 wherein the walking steering apparatus is movable from a stowed position to an extended operational position; wherein the riding throttle is disabled when the walking steering apparatus is in the extended operational position; and wherein the walking throttle is disabled when the walking steering apparatus is in the stowed position.

48. The method of claim 47 wherein the walking steering apparatus comprises a rigid arm pivotally coupled at its lower end to the steering assembly, and carrying the walking throttle at its upper end.

49. The method of claim 46 further comprising:
coupling a braking system to the plurality of wheels;
coupling a riding brake to the braking system for the riding mode of use; and
coupling a walking brake carried by the walking steering apparatus to the braking system for the walking mode of use.

50. The method of claim 49 wherein the walking steering apparatus is movable from a stowed position to an extended operational position; wherein the riding brake is disabled when the walking steering apparatus is in the extended operational position; and wherein the walking brake is disabled when the walking steering apparatus is in the stowed position.
